(19) United States
(12) Patent Application Publication
(10) Pub. No.: US 2025/0190795 A1
(43) Pub. Date: Jun. 12, 2025

(54) MODEL OPTIMIZATION METHOD AND APPARATUS, COMPUTER DEVICE, AND COMPUTER STORAGE MEDIUM

(71) Applicant: TENCENT TECHNOLOGY (SHENZHEN) COMPANY LIMITED, Shenzhen (CN)

(72) Inventor: Tao YANG, Shenzhen (CN)

(21) Appl. No.: 19/057,605

(22) Filed: Feb. 19, 2025

Related U.S. Application Data
(63) Continuation of application No. PCT/CN2023/121159, filed on Sep. 25, 2023.

(30) Foreign Application Priority Data
Jan. 31, 2023 (CN) 2023101134036

(51) Int. Cl. G06N 3/08; G06F 40/284; G06F 40/40

(52) U.S. Cl. CPC G06N 3/08; G06F 40/284; G06F 40/40

(57) ABSTRACT

A model optimization method includes obtaining a pre-trained model and training data including word vectors corresponding to a training text and a reference prediction result of the training text in a target service. The word vectors includes a word vector of each text word in the training text. The method further includes determining an auxiliary training parameter of a target network layer in the pre-trained model, adding the auxiliary training parameter to the target network layer to obtain a modified pre-trained model, calling the modified pre-trained model to generate target word vectors corresponding to the word vectors, respectively, performing the target service based on the target word vectors to obtain a model prediction result corresponding to the training text, and optimizing the auxiliary training parameter in a direction of reducing a difference between the model prediction result and the reference prediction result to obtain a target model.

### CROSS-REFERENCE TO RELATED APPLICATIONS

This application is a continuation of International Application No. PCT/CN2023/121159, filed on Sep. 25, 2023, which claims priority to Chinese Patent Application No. 202310113403.6, entitled “MODEL OPTIMIZATION METHOD AND APPARATUS, COMPUTER DEVICE, AND COMPUTER STORAGE MEDIUM” filed with the China National Intellectual Property Administration on Jan. 31, 2023, the entire contents of both of which are incorporated herein by reference.

### FIELD OF THE TECHNOLOGY

This application relates to the fields of computer science technology and artificial intelligence (AI) technology, and, in particular, to a model optimization method and apparatus, a computer device, and a computer storage medium.

### BACKGROUND OF THE DISCLOSURE

With the emergence of deep learning technology and machine learning (ML) technology in the field of computer technologies, a service provider can implement the development and application of Internet services by using neural network models. To quickly generate a neural network model conforming to an expected application effect, a conventional model optimization method usually uses training samples to optimize model parameters included in a corresponding pre-trained model, to use the pre-trained model with the model parameters optimized as the neural network model conforming to the expected application effect.

Still with the development of computer technologies, a current pre-trained model usually includes a large quantity of model parameters, and some even have over billions of parameters. If a conventional model optimization method is used to optimize a pre-trained model to obtain a target model, optimization efficiency is low due to excessive parameters that need to be optimized. Therefore, how to perform efficient optimization to obtain a target model becomes a current research hotspot.

### SUMMARY

In accordance with the disclosure, there is provided a model optimization method including obtaining a pre-trained model and training data that includes a plurality of word vectors corresponding to a training text and a reference prediction result of the training text in a target service. The plurality of word vectors at least includes a word vector of each text word in the training text. The method further includes determining an auxiliary training parameter of a target network layer in the pre-trained model, adding the auxiliary training parameter to the target network layer to obtain a modified pre-trained model, calling the modified pre-trained model to generate, according to the plurality of word vectors and the auxiliary training parameter, a plurality of target word vectors corresponding to the plurality of word vectors, respectively, performing the target service based on the plurality of target word vectors to obtain a model prediction result corresponding to the training text, and optimizing the auxiliary training parameter in a direction of reducing a difference between the model prediction result and the reference prediction result to obtain a target model.

Also in accordance with the disclosure, there is provided a computer device including a processor, and a computer storage medium storing one or more computer programs that, when executed by the processor, cause the processor to obtain a pre-trained model and training data that includes a plurality of word vectors corresponding to a training text and a reference prediction result of the training text in a target service. The plurality of word vectors at least includes a word vector of each text word in the training text. The one or more computer programs further cause the processor to determine an auxiliary training parameter of a target network layer in the pre-trained model, add the auxiliary training parameter to the target network layer to obtain a modified pre-trained model, call the modified pre-trained model to generate, according to the plurality of word vectors and the auxiliary training parameter, a plurality of target word vectors corresponding to the plurality of word vectors, respectively, perform the target service based on the plurality of target word vectors to obtain a model prediction result corresponding to the training text, and optimize the auxiliary training parameter in a direction of reducing a difference between the model prediction result and the reference prediction result to obtain a target model.

Also in accordance with the disclosure, there is provided a non-transitory computer storage medium storing one or more computer programs that, when executed by a processor, cause the processor to obtain a pre-trained model and training data that includes a plurality of word vectors corresponding to a training text and a reference prediction result of the training text in a target service. The plurality of word vectors at least includes a word vector of each text word in the training text. The one or more computer programs further cause the processor to determine an auxiliary training parameter of a target network layer in the pre-trained model, add the auxiliary training parameter to the target network layer to obtain a modified pre-trained model, call the modified pre-trained model to generate, according to the plurality of word vectors and the auxiliary training parameter, a plurality of target word vectors corresponding to the plurality of word vectors, respectively, perform the target service based on the plurality of target word vectors to obtain a model prediction result corresponding to the training text, and optimize the auxiliary training parameter in a direction of reducing a difference between the model prediction result and the reference prediction result to obtain a target model.

### BRIEF DESCRIPTION OF THE DRAWINGS

To describe the technical solutions in the embodiments of this application more clearly, the accompanying drawings for describing the embodiments are briefly described hereinafter. Apparently, the accompanying drawings in the following description show some embodiments of this application, and a person of ordinary skill in the art may obtain other accompanying drawings from these accompanying drawings without creative efforts.

FIG. 1A is a main schematic structural diagram of a pre-trained model according to an embodiment of this application.

FIG. 1B is a schematic structural diagram of a transformer model according to an embodiment of this application.

FIG. 2 is a schematic flowchart of a model optimization method according to an embodiment of this application.

FIG. 3 is a schematic flowchart of another model optimization method according to an embodiment of this application.

FIG. 4 is a schematic flowchart of another model optimization method according to an embodiment of this application.

FIG. 5 is a schematic structural diagram of a model optimization apparatus according to an embodiment of this application.

FIG. 6 is a schematic structural diagram of a computer device according to an embodiment of this application.

### DESCRIPTION OF EMBODIMENTS

To enable a person skilled in the art to better understand the solution provided in embodiments of this application, the following describes the technical solutions in the embodiments of this application with reference to the accompanying drawings in the embodiments of this application. Specific embodiments described in the embodiments of this application are merely some rather than all of the embodiments of this application. All other embodiments obtained by persons of ordinary skill in the art based on the embodiments of this application without creative efforts shall fall within the scope of this application.

Embodiments of this application provide a model optimization method. Through the method, a target model suitable for performing a target service can be obtained through efficient optimization according to training data and a pre-trained model in the target service. Specifically, the method points out that when a target model configured to perform a target service needs to be obtained, training data and a pre-trained model related to implementation of the target service are obtained, and an auxiliary training parameter is determined for a target network layer of the pre-trained model, to add the auxiliary training parameter to the corresponding target network layer to obtain a pre-trained model with the parameter added. In some embodiments, the target network layer of the pre-trained model includes at least one of a self-attention layer or a fully connected layer, and one self-attention layer and one fully connected layer are provided in one pre-trained model. The training data includes at least a plurality of word vectors corresponding to a training text and a reference prediction result of the training text in the target service, so that a computer device may generate target word vectors corresponding to the word vectors by using the pre-trained model with the parameter added and based on the auxiliary training parameter and the plurality of word vectors included in the training data, and further use the pre-trained model with the parameter added to perform the target service according to the target word vectors corresponding to the word vectors to obtain a model prediction result of the corresponding training text. A difference between the model prediction result and the reference prediction result may be configured for optimizing an auxiliary training parameter. Specifically, the computer device may adjust the auxiliary training parameter in a direction of reducing the difference, to use a pre-trained model including an optimized auxiliary training parameter as the target model configured to perform the target service.

A target model is obtained by adding an auxiliary training parameter to a pre-trained model and optimizing the added auxiliary training parameter. In other words, in a process of obtaining the target model, only the added auxiliary training parameter in the pre-trained model is optimized, and original model parameters in the pre-trained model remains unchanged, so that a quantity of model parameters that need to be optimized in a model optimization process is controlled. Therefore, when the computer device optimizes the pre-trained model with the parameter added, a required calculation amount is greatly reduced. This is highly conducive to shortening an optimization time and saving a storage space, and the shortening of the optimization time reflects that the pre-trained model with the parameter added can quickly converge, so that the embodiments of this application have high efficiency of obtaining the target model.

In addition, as the quantity of model parameters that need to be optimized is reduced, the model depends less on noise and special deviations in training data, so that model overfitting can be effectively mitigated, and the generated target model can have better generalization performance. The generalization performance refers to the ability of the target model to perform on unknown data, and is a capability of applying knowledge learned by the target model from the training data to new service data. Generally, a stronger generalization capability indicates a more accurate prediction result of the model on unknown data. Based on the foregoing description, as can be seen, the target model suitable for performing the target service can be efficiently generated in the embodiments of this application.

In an embodiment, the target service is a service related to natural language processing (NLP). The NLP is an important direction in the field of a computer science technology and the field of an AI technology, and is configured for studying various theories and methods that can implement effective communication between humans and computers by using natural languages. An NLP technology may include technical branches such as text processing, semantic understanding, machine translation, robot question answering, and knowledge graph, so that the NLP technology may be applied to scenarios such as machine translation, auto abstract, opinion extraction, text classification, question answering, text semantic comparison, voice recognition, and Chinese OCR. It can be seen that the NLP is a science that integrates linguistics, computer science, and mathematics. Therefore, research in this field involves a natural language (that is, a language used by people daily), making the NLP closely connected to research in linguistics.

Based on the foregoing related descriptions of the NLP, it is not difficult to understand that the target service may include, but not limited to, one or more of a machine translation service, an auto abstract service, an opinion extraction service, a text classification service, a question answering service, a text semantic comparison service, a voice recognition service, and the like. Based on this, the pre-trained model in the embodiments of this application may be a transformer model commonly used in the NLP. The transformer model may use a self-attention mechanism to process each word vector in an input sequence, so that the transformer model can associate each word vector in the input sequence with a word vector in other context, to detect a word indicated by a corresponding word vector, thereby implementing complete natural language understanding. In the embodiments of this application, the input sequence of the transformer model is a plurality of word vectors corresponding to a training text. A result obtained by implementing complete natural language understanding on the training text by the transformer model is a model prediction result of the training text. In addition, during actual application, the transformer model may perform deep mining for a plurality of semantic correlations (semantic detection, sentiment analysis, syntactic analysis, and the like) in the input sequence, making a natural language understanding task more precise and reliable, so that when a target model optimized based on the model is applied to a target service, a more accurate execution result can be obtained for the target service.

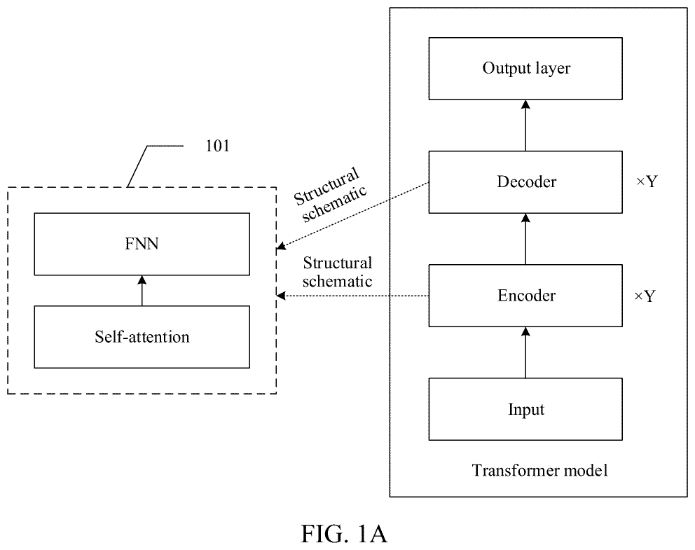

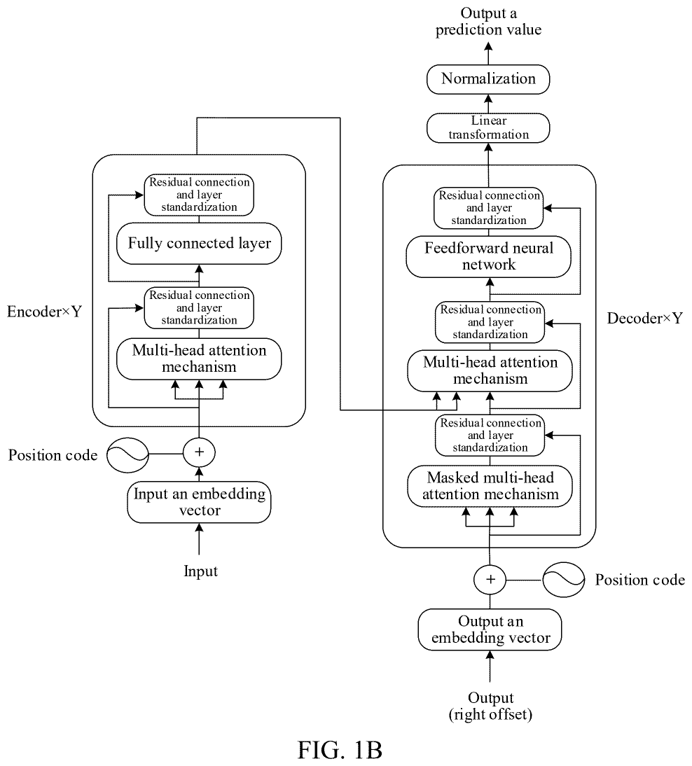

For example, a main structure of the transformer model may be that shown in FIG. 1A, and a detailed structure may be that shown in FIG. 1B. As can be seen based on FIG. 1A, the transformer model includes at least Y groups of encoders and decoders. Y is a positive integer. In other words, in the transformer model, at least Y encoders and Y decoders may exist, and each of the encoders and the decoders is formed by combining a multi-layer stacked self-attention mechanism and a feedforward mechanism. A network structure configured to reflect the multi-layer stacked self-attention mechanism may be used as a self-attention layer, and a network structure configured to reflect the feedforward mechanism may be used as a fully connected layer. In other words, each of the encoders and the decoders includes at least a self-attention layer and a fully connected layer, so that a main structure of the encoder or the decoder may be exemplarily shown by the structure labeled by 101 in FIG. 1A. In addition, as can be seen based on the description of FIG. 1A and the structure shown in FIG. 1B, the transformer model is formed by stacking a plurality of layers of neural networks, the layers of neural networks all have the same structure, and each layer of neural network includes two sublayers. The two sublayers are a self-attention sublayer and a fully neural network (FNN) sublayer (i.e., a fully connected layer). For example, the FNN sublayer includes two fully connected networks, so that the FNN sublayer may be configured to deeply integrate a representation of a current word vector and a representation of context together for further feature representation. Certainly, the transformer model further includes other network structures, and these other network structures have weak association relationships with the inventive concept of this application. Therefore, the other network structures of the transformer model are not described in detail herein in the embodiments of this application.

In an embodiment, the computer device may be used to perform the model optimization method provided in the embodiments of this application, and specifically, the computer device may include one or two types of a terminal device and a server. When the computer device includes a terminal device, an application configured to implement a target service may be run in the terminal device. The application is developed based on a target model obtained by using the model optimization method provided in the embodiments of this application. Certainly, various other applications such as an application of an image processing type, an application of a multimedia playing type, and an application of a navigation type may further be run in the terminal device. The terminal device may specifically include, but not limited to, a smartphone, a tablet computer, a laptop computer, a desktop computer, an in-vehicle terminal, a smart television, and a game console. When the computer device includes a server, the server may provide support services such as a data computing service and a data storage service for the target service. In other words, the server establishes a communication connection with a client (an application) that provides the target service. The server may specifically include, but not limited to, one or more of an independent physical server, a server cluster or a distributed system formed by a plurality of physical servers, and a cloud server providing basic cloud computing services such as a cloud service, a cloud database, cloud computing, a cloud function, cloud storage, a network service, cloud communication, a middleware service, a domain name service, a security service, a content delivery network (CDN), big data, and an AI platform. This is not specifically limited in the embodiments of this application.

For clear understanding of the specific implementations of the embodiments of this application, before a method for generating a target model is formally described, related terms of the AI technology and the embodiments of this application in the field are briefly described.

The AI technology is a comprehensive technology that enables a machine to imitate human intelligence, and is intended to search for a method that makes a machine possess knowledge and skills like a human and manifest same behavior and decision making. In other words, AI studies design principles and implementation methods of various intelligent machines, and based on AI, a machine may have the functions of sensing, reasoning, and decision making. Specifically, the AI technology may use a digital computer or a machine controlled using a digital computer to simulate, extend, and expand the intelligence of humans, to enable the digital computer or the related machine to sense an environment and obtain knowledge. In other words, theories, methods, technologies, and application systems of using the digital computer or the related machine to use knowledge learned by the digital computer or the related machine to obtain an optimal result can be implemented based on AI. During actual application, the AI technology involves wide fields, and includes both technologies at the hardware level and technologies at the software level. An AI hardware technology generally includes sensors, dedicated AI chips, cloud computing, distributed storage, a big data processing technology, operating/interaction systems, mechatronics, and other technologies. An AI software technology generally includes a computer vision technology, a voice processing technology, an NLP technology, an ML/deep learning technology, and other technologies. As can be seen, the AI technology may be applied to NLP (including voice recognition, text classification, machine translation, and the like), machine vision, intelligent robots, and other fields.

As easily seen based on the foregoing description, the ML technology is a branch of the AI technology. The main principle of the ML technology is implementing machine thinking and learning based on a large amount of data and algorithms, to implement automatic improvement of a computer program, thereby implementing autonomous learning and self-adjustment without human intervention, so that a large amount of human resources is saved. In other words, based on the ML technology, a computer can continuously obtain new knowledge or skills, and can reorganize an existing knowledge structure, so that the computer can continuously improve the performance of the computer, thereby achieving a better intelligent processing effect (for example, an image recognition effect, a text translation effect, or a voice generation effect). During actual application, the principle of the ML technology may be applied to a model optimization process. Subsequently, in the embodiments of this application, the ML technology is also used to obtain a target model. Specifically, the deep learning technology and the NLP technology in the ML technology are used. The deep learning technology is a multi-field cross-discipline, and may specifically relate to a plurality of disciplines such as probability theory, statistics, approximation theory, convex analysis, and algorithm complexity theory. In addition, the deep learning technology is mainly applied to a multi-layer neural network model, and each layer of neural network may obtain more features from a previous layer of neural network, so that the computer device may perform complex data analysis by using the deep learning technology, thereby obtaining a more accurate service execution result. In this case, a target model generated by using the deep learning technology also has higher model performance.

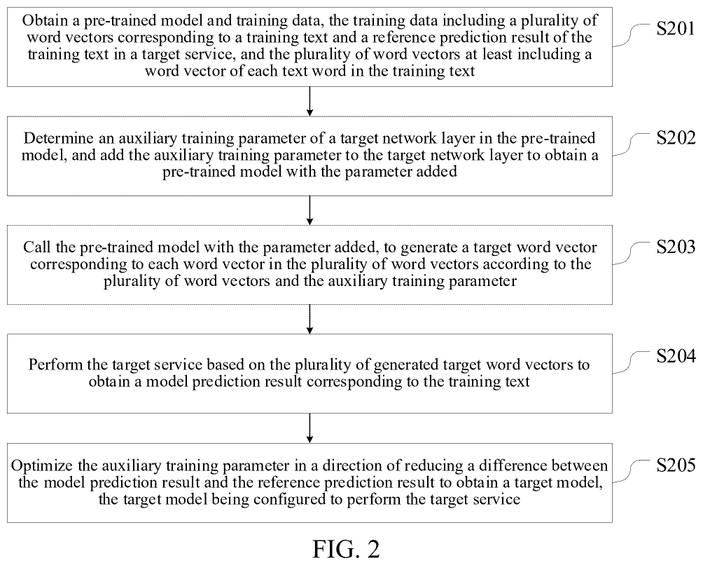

FIG. 2 is a schematic flowchart of a model optimization method according to an embodiment of this application. The model optimization method may be performed by the foregoing computer device, and as shown in FIG. 2, the method may include operations S201 to S205:

S201: Obtain a pre-trained model and training data, the training data including a plurality of word vectors corresponding to a training text and a reference prediction result of the training text in a target service, and the plurality of word vectors at least including a word vector of each text word in the training text.

In an embodiment, the pre-trained model is a neural network model that has undergone a large amount of training using a corpus before the target service is implemented. For the pre-trained model, a large-scale training corpus has already been used to recognize semantic representations representing concepts at levels of fields such as syntax, semantics, and knowledge. Therefore, feature information configured for the target service can be quickly extracted by further optimizing the pre-trained model using the training data related to the target service, to quickly generate a target model configured to perform the target service. The training data is sample data used in an ML algorithm, and is configured for helping the pre-trained model further learn a feature extraction manner related to the target service, to enable the computer device to accurately complete the target service based on the pre-trained model. In some embodiments, the training data may be understood as various observed values used to adjust model parameters during model training. These observed values may be extracted from a historical data set in the target service, or may be constructed based on a service requirement of the target service. This is not limited in the embodiments of this application.

In an embodiment, the training data may include the plurality of word vectors corresponding to the training text, and the training text may be inputted into the computer device, or may be obtained by recognizing another signal (e.g., a voice signal, or an image signal) by the computer device. This is not limited in the embodiments of this application. The word vector is a numerical manner configured for representing a word (or referred to as a text word, which may include a single word, a phrase, and the like) in the training text, and maps each single word or phrase into a numerical space of a fixed dimension to represent a corresponding single word or phrase. In some embodiments, a generation manner of the word vector includes feature hashing, hierarchical softmax, a neural network language model, a co-occurrence matrix, deep learning techniques, word embeddings, and the like.

During actual application, the plurality of word vectors corresponding to the training text at least include the word vectors of the text words in the training text. The pre-trained model in the embodiments of this application may be a transformer model. The transformer model may use an encoder to map a variable-length input sequence into a vector of a fixed length and use a decoder to map an input of the fixed length back to a variable-length output sequence, so that the pre-trained model in the embodiments of this application can process the variable-length input sequence. The variable-length input sequence is an input sequence including word vectors of different lengths. In other words, in the embodiments of this application, among the plurality of word vectors corresponding to the training text, vector lengths of the word vectors may be different, or certainly may be the same. When the vector lengths of the word vectors are the same, the encoder and the decoder may not need to map the word vectors to a fixed length, so that a processing load of the pre-trained model is reduced, and the speed of model training can be increased to some extent. Each vector length is a dimension of a vector. For example, when the vector lengths are the same, the vector lengths of the vectors may be a fixed size of a dimension of 50 or a dimension of 100, or certainly may be another dimension. This is not limited in the embodiments of this application.

In an embodiment, to enable the pre-trained model to use more input data to learn more comprehensive feature information to generate a target model with higher model performance, the plurality of word vectors in the training data may further include one or more input word vectors. An arrangement position of the one or more input word vectors in an input sequence is located before the word vectors of the text words in the training text. In other words, assuming that the input word vectors are Va and Vb and the word vectors of the text words in the training text are respectively V1, V2, and V3, the input sequence is [Va, Vb, V1, V2, and V3]. Each input word vector in the input sequence may be randomly generated by the computer device, and a quantity and vector lengths of the input word vectors may also be randomly specified, or set according to the service requirement of the target service. This is not limited in the embodiments of this application. In other words, when there are a plurality of input word vectors, the plurality of input word vectors may have the same vector length or may have different vector lengths.

In some embodiments, the vector lengths of the input word vectors in the embodiments of this application may be the same as the vector lengths of the word vectors of the text words in the training text, and the vector lengths of the word vectors of the text words in the training text may be the same, to reduce a processing load of a corresponding model, thereby increasing a generation rate of the target model. In addition, each input word vector may be trained together with the pre-trained model. In other words, the input word vector may be optimized in a training process of the pre-trained model. In this case, when different training texts exist, input word vectors corresponding to the different training texts may be different. However, the input word vector corresponding to each training text is obtained through optimization according to the same group of input word vectors, and the group of input word vectors is generated when the computer device trains the pre-trained model by using the first training text.

In an embodiment, the training data further includes the reference prediction result of the training text. The reference prediction result is annotation information of the training text in the target service, and is configured for indicating an expected prediction result obtained when the target service is performed on the training text. In some embodiments, the reference prediction result of the training text may be manually annotated or may be generated in another manner. When a difference between an execution result obtained when the model performs the target service on the training text and the reference prediction result is smaller, it may be considered that accuracy of performing the target service by the model is higher. For example, when the target service is a text classification service, the reference prediction result of the training text may be a classification result expected to be obtained for the training text in the text classification service. The reference prediction result has a high degree of matching with the training text. In this way, in a process of actually performing the text classification service based on the training text, when a similarity between an obtained classification result and the reference prediction result is higher, it is considered that accuracy of performing the text classification service by the corresponding model is higher.

S202: Determine an auxiliary training parameter of a target network layer in the pre-trained model, and add the auxiliary training parameter to the target network layer to obtain a pre-trained model with the parameter added. The pre-trained model with the parameter added is also referred to as a “modified pre-trained model.”

In an embodiment, a manner of determining the auxiliary training parameter is related to the target network layer. In other words, when the target network layer varies, the computer device uses a different manner to determine the auxiliary training parameter suitable for the target network layer.

In some embodiments, the target network layer includes at least one of a self-attention layer or a fully connected layer.

In an embodiment, the target network layer may include a self-attention layer, and for example, when the target network layer is a self-attention layer, the computer device may generate an auxiliary training parameter of the self-attention layer in a manner of generating an auxiliary training word vector, to enable the self-attention layer to learn a more complex and comprehensive word vector understanding capability. Specifically, a noise error in the training data can be eliminated by adding a parameter to the self-attention layer, so that the model can capture semantic meanings more accurately, and the accuracy, expression capability, and processing capability of processing a natural language task by the model.

In an embodiment, the target network layer may include a fully connected layer. The fully connected layer is a cornerstone commonly used in a neural network. The fully connected layer may connect a previous-layer network and a next-layer network, to transfer features outputted by the previous-layer network to the next-layer network, and combines the features to form a feature combination that has not been considered by the previous-layer network, thereby capturing more complex feature information. When the target network layer is a fully connected layer, the computer device may generate an auxiliary training parameter of the fully connected layer in a manner of generating an auxiliary training matrix, to enable the fully connected layer to combine various features in a more complex manner, thereby capturing more complex and comprehensive feature information, so that the accuracy of the generated target model can be effectively improved.

S203: Call the pre-trained model with the parameter added, to generate a target word vector corresponding to each word vector in the plurality of word vectors according to the plurality of word vectors and the auxiliary training parameter.

In an embodiment, the auxiliary training parameter is added to the target network layer by the computer device after the target network layer is generated. Therefore, the auxiliary training parameter is not an original model parameter in the pre-trained model, and information expressed by the auxiliary training parameter is unrelated to the pre-trained model. Therefore, the auxiliary training parameter is added to the target network layer of the pre-trained model, so that information used as a reference in a process of performing the target service by the pre-trained model with the parameter added can be enriched, and compared with an original word vector, the target word vector generated using the auxiliary training parameter as a reference can express more complex and richer feature information. In addition, because the auxiliary training parameter is added to the pre-trained model and the auxiliary training parameter can be optimized and adjusted, the pre-trained model with the parameter added can perform optimization and adjustment based on training data related to the target service in a wider range. Therefore, the target model obtained by optimizing the training data can better fit the service requirement of the target service, so that the target model can generate an execution result with higher accuracy for the target service.

When the target network layer varies, the auxiliary training parameter added to the pre-trained model is different, and a manner in which the computer device generates, based on the auxiliary training parameter and the plurality of word vectors, target word vectors corresponding to the word vectors also varies. In some embodiments, when the target network layer is a self-attention layer, for any word vector, when generating a target word vector of the word vector by using the pre-trained model with the parameter added, the computer device may use vector similarities between the word vector and various word vectors in the plurality of word vectors and vector similarities between the word vector and various auxiliary training parameters as a reference, thereby achieving the objective of comprehensively combining context information to generate a target word vector with a representation capability stronger than the word vector. Therefore, although the target word vector corresponding to each word vector is generated based on the same plurality of word vectors and auxiliary training parameters, because vector similarities between corresponding word vectors are different, the computer device can generate corresponding different target word vectors for different word vectors.

Correspondingly, when the target network layer is a fully connected layer, for any word vector, when generating a target word vector of the word vector by using the pre-trained model with the parameter added, the computer device may use an auxiliary training parameter to perform a corresponding operation on the word vector to generate the target word vector corresponding to the word vector. In other words, when the target network layer is a fully connected layer, the target word vector corresponding to any word vector is in fact generated based on the word vector and the auxiliary training parameter, so that the computer device may generate a corresponding target word vector for each word vector based on the plurality of word vectors and the auxiliary training parameter added to the fully connected layer. The auxiliary training parameter added to the fully connected layer is essentially a matrix. A parameter of a matrix type is added to the fully connected layer, and a corresponding operation is performed on a word vector and the matrix, so that the pre-trained model with the parameter added can learn more feature structures, and can perform more complex feature expression for the word vector, and eventually the target model obtained by optimizing the pre-trained model with the parameter added has a better expression capability.

S204: Perform the target service based on the plurality of generated target word vectors to obtain a model prediction result corresponding to the training text.

S205: Optimize the auxiliary training parameter in a direction of reducing a difference between the model prediction result and the reference prediction result to obtain a target model, the target model being configured to perform the target service.

In an embodiment, the difference between the model prediction result and the reference prediction result may be configured for measuring model performance of a current model, and the model performance may be, for example, flexibility, accuracy, and generalization. Specifically, when the difference between the model prediction result and the reference prediction result is smaller, the model performance of the current model is better. During actual application, the difference may be reflected by a loss value, and the value of the difference is positively correlated with the loss value. In other words, when the loss value is larger, the difference between the model prediction result and the reference prediction result is larger. The loss value is calculated by using a loss function. Different loss functions may be correspondingly used for different target services. The loss function is not limited in the embodiments of this application.

For example, if the target service in the embodiments of this application is a text classification service, a softmax loss function, a support vector machine (SVM) loss function, and/or the like may be used. Based on this, the optimization of the auxiliary training parameter in the direction of reducing the difference may be understood as optimization of the auxiliary training parameter in a direction of reducing the loss value. Because the loss value can be quantified (represented by a value), an optimization target may be represented by a preset loss value, so that when the loss value determined by the current model based on the difference between the model prediction result and the corresponding reference prediction result is less than or equal to the preset loss value, it is determined that the currently obtained optimized model has reached the optimization target, so that the optimized model can be used as the target model.

In the embodiments of this application, a target model is obtained by adding an auxiliary training parameter to a pre-trained model and optimizing the added auxiliary training parameter. As can be seen, in a process of obtaining the target model, only the added auxiliary training parameter in the pre-trained model is optimized, and original model parameters in the pre-trained model are kept unchanged, so that a quantity of model parameters that need to be optimized in a model optimization process is small. Therefore, during optimization of the pre-trained model with the parameter added, a required calculation amount is greatly reduced. This is highly conducive to shortening an optimization time and saving a storage space, and the shortening of the optimization time reflects that the pre-trained model with the parameter added can quickly converge, so that the embodiments of this application has a high rate of obtaining the target model. In addition, as the quantity of model parameters that need to be optimized is small, the model depends less on noise and special deviations in training data, so that model overfitting can be effectively mitigated, and the generated target model can have better generalization performance. In addition, in some embodiments, the auxiliary training parameter is added to a self-attention layer and/or a fully connected layer, and the self-attention layer and the fully connected layer usually include many parameters and have a complex use manner. Therefore, when the pre-trained model with the parameter added performs a target service based on the training data, complex interaction can be performed between the added auxiliary training parameter and existing parameters in the pre-trained model, so that the pre-trained model with the parameter added can use the auxiliary training parameter to learn more new features, and can better generalize new data. In this way, the target model obtained by optimizing the pre-trained model with the parameter added can better adapt to the target service. Therefore, the target model generated in the embodiments of this application can have higher accuracy in performing the target service. In summary, as can be seen, the target model suitable for performing the target service can be efficiently generated in the embodiments of this application.

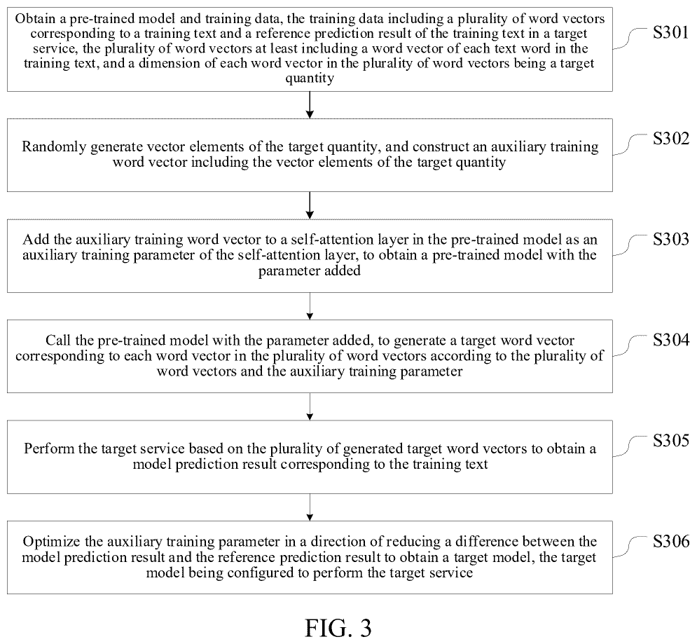

FIG. 3 is a schematic flowchart of another model optimization method according to an embodiment of this application. The model optimization method may still be performed by the foregoing computer device, and as shown in FIG. 3, the method may include operations S301 to S306:

S301: Obtain a pre-trained model and training data, the training data including a plurality of word vectors corresponding to a training text and a reference prediction result of the training text in a target service, and the plurality of word vectors at least including a word vector of each text word in the training text.

In an embodiment, for a related implementation of operation S301, refer to a specific embodiment of operation S201, and details are not described in the embodiments of this application.

S302: Randomly generate vector elements of a target quantity, and construct an auxiliary training word vector including the vector elements of the target quantity.

In an embodiment, a vector is an abstract mathematical concept and is formed by a group of digits, and each digit forming the vector is referred to as a vector element. Without exception, the word vector in the embodiments of this application is also formed by one or more vector elements represented by digits, and a quantity of the vector elements forming the word vector may be referred to as a dimension of the word vector. The word vector in the embodiments of this application includes at least the auxiliary training word vector, a target word vector, and the plurality of word vectors corresponding to the training text. The plurality of word vectors corresponding to the training text includes at least the word vector of each text word in the training text. In some embodiments, the plurality of word vectors corresponding to the training text may further include one or more input word vectors.

The word vector of each text word in the training text is generated by the computer device based on the corresponding text word. The word vector of each text word is configured for representing feature information of the text word. The feature information specifically includes, but is not limited to, one or more of a semantic feature of the text word, a syntactic feature of the text word, and a contextual relationship between the text word and another text word. In some embodiments, an input sequence of the pre-trained model may be a fixed-length sequence, i.e., word vectors processed by the pre-trained model have the same dimension, so that a processing load of the corresponding model is reduced, thereby improving development efficiency of a corresponding service. In this case, the plurality of word vectors corresponding to the training text all have the same dimension. Therefore, the computer device may first obtain a dimension of any word vector in the plurality of word vectors corresponding to the training text, to randomly generate corresponding one or more vector elements. A quantity of the one or more vector elements is the same as the dimension of any word vector.

In an implementation, the pre-trained model (i.e., a transformer model) may process a variable-length input sequence. Therefore, a dimension of the auxiliary training word vector may be a random quantity. Certainly, for ease of actual processing, the random quantity may be restricted within a quantity range. For example, the quantity range may be specified in advance, or may be determined according to dimensions of the plurality of word vectors corresponding to the training text. For example, the quantity range is generated based on the smallest dimension and the largest dimension in the dimensions corresponding to the plurality of word vectors. In other words, the computer device may generate vector elements of a random quantity, so that the vector elements of the random quantity are used as a basis, and each vector element may also be generated in a random generation manner.

In addition, as can be learned from the foregoing operation S201, the plurality of word vectors corresponding to the training text may further include one or more input word vectors, and the input word vector may be randomly generated by the computer device. In this case, in some embodiments, a random generation manner of each input word vector in the embodiments of this application may be the same as a generation manner of the auxiliary training word vector. To be specific, the computer device randomly generates vector elements of a corresponding quantity, and further stores the vector elements of the target quantity in one vector, to implement the random generation of the corresponding input word vector. The random generation manner of the input word vector is not described in detail again in the embodiments of this application.

S303: Add the auxiliary training word vector to a self-attention layer in the pre-trained model as an auxiliary training parameter of the self-attention layer, to obtain a pre-trained model with the parameter added.

In an embodiment, the computer device may generate one or more auxiliary training word vectors according to the method described in operation S302, so that the self-attention layer may have one or more auxiliary training parameters. Still, generally, a transformer model includes at least one self-attention layer. Therefore, the computer device may respectively generate corresponding one or more auxiliary training parameters for each self-attention layer. In some embodiments, the computer device may generate different one or more auxiliary training parameters for different self-attention layers, so that a transformer model with the parameter added can learn more comprehensive and complex context information, and a target model obtained through optimization based on the transformer model with the parameter added has higher model performance. When any auxiliary training parameter in a first self-attention layer is different from all auxiliary training parameters included in a second self-attention layer, it may be determined that the first self-attention layer and the second self-attention layer include different one or more auxiliary training parameters, and the first self-attention layer and the second self-attention layer may be any two different self-attention layers in the self-attention layers included in the transformer model.

S304: Call the pre-trained model with the parameter added, to generate a target word vector corresponding to each word vector in the plurality of word vectors according to the plurality of word vectors and the auxiliary training parameter.

In an embodiment, the pre-trained model with the parameter added may include one or more auxiliary training parameters (i.e., the one or more auxiliary training word vectors). In this case, when generating a corresponding target word vector for any word vector, the computer device may first determine a vector similarity between the word vector and each auxiliary training word vector, and determine a vector similarity between the word vector and each word vector in the plurality of word vectors corresponding to the training text, to generate the target word vector corresponding to the word vector based on the vector similarity corresponding to each auxiliary training word vector, the vector similarity corresponding to each word vector in the plurality of word vectors corresponding to the training text, one or more auxiliary training word vectors, and the plurality of word vectors corresponding to the training text.

A vector similarity between two word vectors is closely related to context information between the two. Specifically, a similarity between word vectors may be configured for indicating a semantic correlation between the corresponding two word vectors, the word vectors represent semantic information of one text word, and the semantic information is affected by a context environment of the text word, so that the computer device may determine, by determining the vector similarity between the two word vectors, a degree of similarity between context information of the two, to further determine semantic information of the corresponding word vectors. When the vector similarity between the word vectors is higher, it represents that the word vectors have more similar context information.

For example, the computer device may calculate a vector similarity between any word vector (it is assumed that the word vector is an i^{th} word vector) and any auxiliary training word vector in a manner shown in Formula 1. In Formula 1, V_{token_i} represents the i^{th} word vector in the plurality of word vectors corresponding to the training text; V_{M_k} represents a k^{th} auxiliary training word vector in M auxiliary training word vectors, and Mis a positive integer; and S_{i,k} represents a vector similarity between the i^{th} word vector and the k^{th} auxiliary training word vector, and dot represents performing a dot product operation on two vectors in brackets.

$${S}_{i , k} = dot ( {V}_{token \_ i} , {V}_{M \_ k} ) \qquad Formula 1$$

In addition, for example, the computer device may calculate a vector similarity between the i^{th} word vector and any word vector in the plurality of word vectors in a manner shown in Formula 2, and the i^{th} word vector may be any of the plurality of word vectors. In Formula 2, V_{token_j} represents a j^{th} word vector in the plurality of word vectors corresponding to the training text; V_{token_i} represents the i^{th} word vector in the plurality of word vectors corresponding to the training text; and S_{i,j} represents a vector similarity between the j^{th} word vector and the i^{th} word vector, and dot represents performing a dot product operation on V_{token_i} and V_{token_j} in brackets.

$${S}_{i , j} = dot ( {V}_{token \_ j} , {V}_{token \_ i} ) \qquad Formula 2$$

In an embodiment, feature information represented by a target word vector corresponding to any word vector is more comprehensive than feature information represented by the word vector. Therefore, during generation of a target word vector of any word vector, the computer device may determine, by referring to vector similarities corresponding to word vectors, a reference degree of a corresponding word vector by the computer device. In some embodiments, during the generation of a target word vector corresponding to any word vector, if a vector similarity corresponding to a word vector (for ease of description, it is assumed that the word vector is a word vector C) is higher, a reference degree of a word vector C by the computer device is higher, so that semantic information represented by the target word vector corresponding to the any word vector is more similar to semantic information represented by the word vector C.

During actual application, the reference degree may be indicated by a vector weight. In this case, the computer device may generate a target word vector corresponding to any word vector by referring to vector weights of word vectors. Specifically, for a manner in which the computer device generates a target word vector corresponding to any word vector, referring to the following description: determining, by the computer device according to a vector similarity corresponding to each auxiliary training word vector, a vector weight of the auxiliary training word vector, and determining a vector weight of the word vector according to a vector similarity corresponding to each word vector in the plurality of word vectors corresponding to the training text. The vector weight is positively correlated with the corresponding vector similarity. For example, assuming that any word vector is represented by a word vector A and a vector similarity between a word vector B and the word vector A is a, a value obtained by normalizing the vector similarity a may be used as a vector weight of the word vector B, and when the vector similarity a is higher, the vector weight corresponding to the word vector B is larger.

In addition, the vector weight may be a value obtained by normalizing (or standardizing) a corresponding vector similarity by the computer device, and for example, the computer device may normalize a vector similarity of an auxiliary training word vector in a manner shown in Formula 3 to obtain a vector weight of the auxiliary training word vector.

$${β}_{i , k} = \frac{{e}^{{S}_{i , k}}}{{e}^{{S}_{i , 1}} + {e}^{{S}_{i , 2}} + {e}^{{S}_{i , 3}} + … + {e}^{{S}_{i , M}}} \qquad Formula 3$$

In Formula 3, β_{i,k} represents a vector weight corresponding to the k^{th} auxiliary training word vector in a process of determining a target word vector corresponding to the i^{th} word vector; and e^{S}^{_{i,k}} is a value of an exponential function, where e is the base in the exponential function, and S_{i,k} is the exponent in the exponential function, and S_{i,k} represents the vector similarity between the k^{th} auxiliary training word vector and the i^{th} word vector. Similarly, other parameters in Formula 3 can be understood, and details are not described herein again.

In addition, for example, the computer device may normalize a vector similarity of each word vector corresponding to the training text in a manner shown in Formula 4 to obtain a vector weight of the corresponding word vector. In Formula 4, α_{i,j} represents a vector weight corresponding to the j^{th} word vector in the plurality of word vectors corresponding to the training text in the process of determining the target word vector corresponding to the i^{th} word vector. e^{S}^{_{i,j}} is a value of an exponential function, where e is the base in the exponential function, and S_{i,j} is the exponent in the exponential function, and S_{i,j} represents the vector similarity between the j^{th} word vector and the i^{th} word vector. Similarly, other parameters in Formula 4 can be understood, and details are not described herein again.

$${α}_{i , j} = \frac{{e}^{{S}_{i , j}}}{{e}^{{S}_{i , 1}} + {e}^{{S}_{i , 2}} + {e}^{{S}_{i , 3}} + … + {e}^{{S}_{i , n}}} \qquad Formula 4$$

In other embodiments, the computer device may certainly normalize or standardize the vector similarity in another manner. A manner of normalization or standardization is not limited in the embodiments of this application. For example, the another manner may include, but not limited to, one or more of the following (1) to (4):

(1) Z-Score standardization: The standardization of a vector similarity is implemented by subtracting a corresponding average similarity from the vector similarity to calculate a difference and dividing the difference by a standard deviation. The average similarity may be an average value of vector similarities corresponding to one or more auxiliary training parameters.

(2) Min-Max standardization: The standardization of a vector similarity is implemented by subtracting a corresponding minimum similarity from the vector similarity to calculate a difference and dividing the difference by a difference between a maximum similarity and the minimum similarity. The maximum similarity is the largest value in vector similarities corresponding to one or more auxiliary training parameters, and the minimum similarity is the smallest value in the vector similarities.

(3) Norm normalization: The normalization of a vector similarity is implemented by dividing a value of the vector similarity by a norm. The norm is a function for measuring a “size” of a point in a vector space, is a non-negative real-valued function, and satisfies some specific triangle inequalities. The norm is often configured for measuring a size of a vector or matrix, and may provide information about the vector or matrix.

(4) Logarithmic function normalization: The normalization of a vector similarity is implemented by processing the vector similarity by using a logarithmic function.

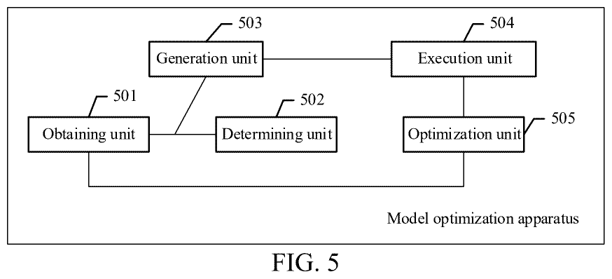

In an embodiment, after determining the vector weights of the auxiliary training word vectors, the computer device may perform, based on a vector weight of each auxiliary training word vector in the one or more auxiliary training word vectors, a weighting operation on the one or more auxiliary training word vectors to obtain a first reference word vector corresponding to the any word vector. Similarly, after the computer device determines the vector weights of the word vectors corresponding to the training text, the computer device may perform, based on a vector weight of each word vector in the plurality of word vectors corresponding to the training text, a weighting operation on the plurality of word vectors, to obtain a second reference word vector corresponding to the any word vector, so that the computer device may perform vector fusion according to the first reference word vector, the second reference word vector, and the any word vector, to eventually obtain a target word vector corresponding to the any word vector. For example, the vector fusion may be a vector weighting operation (e.g., a weighted summation operation, or a weighted averaging operation), or processing shown in FIG. 5.

$${V}_{new \_ token \_ i} = Layer\_norm ( {V}_{token \_ i} + {V}_{c o n text \_ token \_ i} + {V}_{soft \_ token \_ i} ) \qquad Formula 5$$

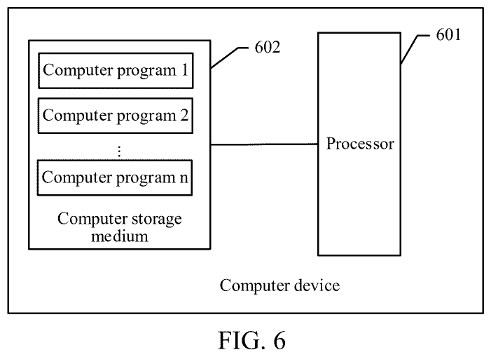

In Formula 5, V_{new_token_i} represents the target word vector corresponding to the i^{th} word vector, V_{token_i} represents the i^{th} word vector, V_{context_token_i} represents the second reference word vector corresponding to the i^{th} word vector, and V_{soft_token_i} represents the first reference word vector corresponding to the i^{th} word vector. Layer_norm is a normalization function, and is configured for standardizing the first reference word vector, the second reference word vector, and the i^{th} word vector. For example, a generation manner of the first reference word vector V_{soft_token_i} may be shown in FIG. 6, and a generation manner of the second reference word vector V_{context_token_i} may be shown in FIG. 7.

$${V}_{soft \_ token \_ i} = {β}_{i , 1} {V}_{M \_ 1} + … + {β}_{i , M} {V}_{M \_ M} \qquad Formula 6$$

In Formula 6, β_{i,1} represents a vector weight corresponding to the first auxiliary training word vector during determination of the target word vector for the i^{th} word vector, and similarly, other parameters in the form of β_{i,*} may be understood. V_{M_1} represents the first auxiliary training word vector in the M auxiliary training word vectors, and similarly other parameters in the form of V_{M_*} may be understood. M is a quantity of auxiliary training parameters added to the self-attention layer.

$${V}_{context \_ token \_ i} = {α}_{i , 1} {V}_{token \_ 1} + … + {α}_{i , n} {V}_{token \_ n} \qquad Formula 7$$

In Formula 7, α_{i,1} represents a vector weight corresponding to the first word vector in n word vectors corresponding to the training text during determination of the target word vector for the i^{th} word vector, and similarly parameters of other parameters in the form of α_{i,*} may be understood. V_{token_1} represents the first word vector in the n word vectors, and similarly other parameters in the form of V_{token_*} may be understood. It is not difficult to understand that n is a quantity of the word vectors corresponding to the training text.

S305: Perform the target service based on the plurality of generated target word vectors to obtain a model prediction result corresponding to the training text.

S306: Optimize the auxiliary training parameter in a direction of reducing a difference between the model prediction result and the reference prediction result to obtain a target model, the target model being configured to perform the target service.

In an embodiment, for a specific implementation of operation S305 and operation S306, refer to related embodiments about operation S204 and operation S205. Details are not described herein again.

In the embodiments of this application, a target model is obtained by adding an auxiliary training parameter to a self-attention layer in a pre-trained model and optimizing the added auxiliary training parameter. In other words, it is not necessary to include original model parameters in the pre-trained model in an optimization range, so that a quantity of model parameters that need to be optimized in a model optimization process is small, and a calculation amount of parameters required for the computer device to optimize a pre-trained model with parameters added is also significantly reduced. In this way, a training duration is effectively reduced, thereby reflecting the characteristic of a high rate of obtaining a target model in the embodiments of this application. In addition, an auxiliary training parameter is added to a self-attention layer, and the self-attention layer usually includes a large quantity of parameters that are difficult to use. Therefore, when a target service is performed based on training data by using a pre-trained model with a parameter added, the added auxiliary training parameter can fully interact with existing parameters in the pre-trained model, so that processing logic with complex interactions can be modeled in a case of adding a small quantity of parameters. In other words, the pre-trained model in which the auxiliary training parameter is added to the self-attention layer may use the auxiliary training parameter to learn more new features, so that the pre-trained model with the parameter added can be better generalized to new data. In this way, the target model obtained by optimizing the pre-trained model with the parameter added can better adapt to the target service, reflecting that the target model generated in the embodiments of this application can have higher accuracy in performing the target service. In summary, the target model suitable for performing the target service can be obtained through efficient optimization in the embodiments of this application.

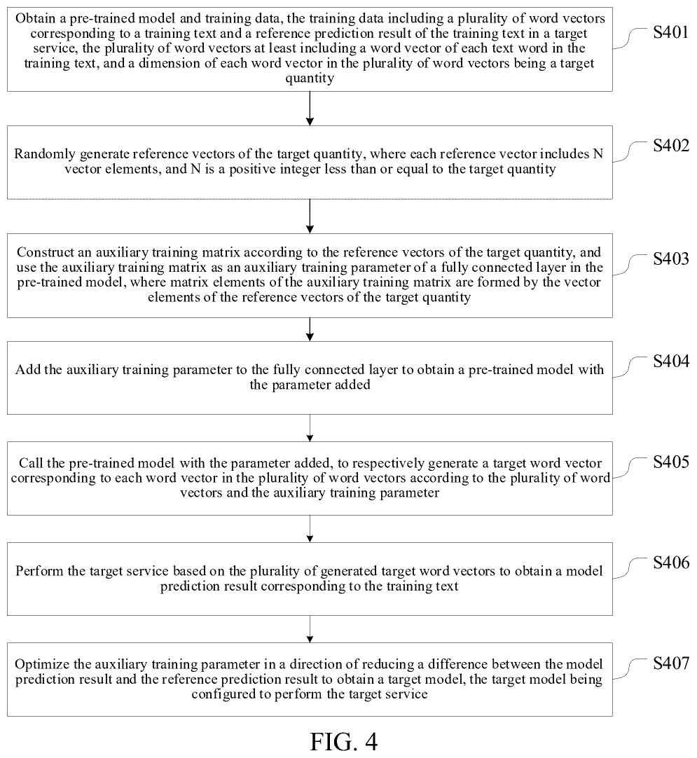

FIG. 4 is a schematic flowchart of another model optimization method according to an embodiment of this application. The model optimization method may still be performed by the foregoing computer device, and as shown in FIG. 4, the method may include operations S401 to S407:

S401: Obtain a pre-trained model and training data, the training data including a plurality of word vectors corresponding to a training text and a reference prediction result of the training text in a target service, the plurality of word vectors at least including a word vector of each text word in the training text, and a dimension of each word vector in the plurality of word vectors being a target quantity.

In an embodiment, for a related implementation of operation S401, refer to a specific embodiment of operation S201, and details are not described in the embodiments of this application.

S402: Randomly generate reference vectors of the target quantity, where each reference vector includes N vector elements, and Nis a positive integer less than or equal to the target quantity.

In an embodiment, the computer device may generate the reference vectors of the target quantity. One reference vector is configured for optimizing and adjusting one vector element in a word vector, to enable feature information indicated by the corresponding word vector to fit a service requirement of the target service. In the reference vectors of the target quantity, each reference vector is randomly generated, and for a generation manner, refer to the foregoing generation manner of an auxiliary training word vector in operation S302 and operation S303. Details are not described herein again.

S403: Construct an auxiliary training matrix according to the reference vectors of the target quantity, and use the auxiliary training matrix as an auxiliary training parameter of a fully connected layer in the pre-trained model, where matrix elements of the auxiliary training matrix are formed by the vector elements of the reference vectors of the target quantity.

In an embodiment, the computer device may generate a plurality of groups of reference vectors according to operation S402, and each group of reference vectors includes the reference vectors of the target quantity, so that the computer device may generate one auxiliary training matrix according to one group of reference vectors, to further construct a plurality of auxiliary training parameters of the fully connected layer. In some embodiments, in an implementation, one auxiliary training parameter of the fully connected layer may be provided, i.e., the computer device generates one auxiliary training matrix. In this case, a dimension of the reference vectors forming the auxiliary training matrix may be the target quantity. In other words, the auxiliary training matrix is a matrix with a quantity of rows equal to a quantity of columns, and the quantity of rows and the quantity of columns are both the target quantity.

In some embodiments, in another implementation, two auxiliary training parameters of the fully connected layer may be provided. For ease of description, the two auxiliary training parameters are referred to as a first auxiliary training parameter and a second auxiliary training parameter. The first auxiliary training parameter may be configured for performing feature dimension increase on a word vector, and the second auxiliary training parameter is configured for performing feature dimension reduction on the word vector after the dimension increase to restore an original dimension of the word vector. Specifically, when the word vector is a row vector, the first auxiliary training parameter may include reference row vectors of the target quantity, and for example, a dimension N of each reference row vector may be any positive integer less than the target quantity and greater than 1. The row vector is essentially a one-dimensional array, and is represented by the vector elements of the target quantity in a row form. In addition, the second auxiliary training parameter may include reference column vectors of the target quantity, and a dimension of each reference column vector is the same as the dimension of the reference row vector in the first auxiliary training parameter. The column vector is a one-dimensional array represented by the vector elements of the target quantity in a column form. Correspondingly, when the word vector is a column vector, the first auxiliary training parameter may be a matrix including reference column vectors of the target quantity, and a dimension N of each reference column vector may be any positive integer less than the target quantity and greater than 1. The second auxiliary training parameter may be a matrix including reference row vectors of the target quantity, and a dimension of each reference row vector is the same as the dimension of the reference column vector in the first auxiliary training parameter.

A generation manner of the first auxiliary training parameter and the second auxiliary training parameter and beneficial effects brought by the generation manner are described below with reference to a specific example. In this example, it is assumed that the word vector is a 1*4 row vector, and is specifically, (x1, x2, x3, x4). In this case, the first auxiliary training parameter is formed by four row vectors. A dimension of each row vector is N, and N is specifically any integer value within a range (1, 4]. In this example, N=2, 3, or 4. The second auxiliary training parameter is formed by four column vectors, and a dimension of each column vector is also N. In this case, each auxiliary training matrix includes a plurality of matrix elements, and each matrix element needs to be determined through optimization and adjustment in a process of obtaining a target model. Therefore, during the optimization of the added auxiliary training parameter, a quantity of parameters that actually need to be optimized may be seen as a quantity of matrix elements included in all auxiliary training matrices. In this example, the quantity of parameters that need to be optimized is 2*4*N (i.e., 4*N+4*N).

If the computer device generates one auxiliary training matrix for the fully connected layer, a quantity of rows and a quantity of columns of the auxiliary training matrix are both the target quantity (in this example, the target quantity is 4). Therefore, a quantity of matrix elements included in the auxiliary training matrix is the square of the target quantity (i.e., 4*4=16). In this case, the quantity of parameters that need to be optimized and adjusted in the process of obtaining the target model is 16. When the computer device generates two auxiliary training matrices for the fully connected layer, the quantity of parameters that need to be optimized is 2*4*N. If N is further restricted to be a positive integer within (1, the target quantity/2], the value of 2*3*N is less than 16, so that in the process of obtaining the target model, it can be ensured that a dimension of a target word vector processed when the model performs the target service is the target quantity, and the quantity of parameters that need to be optimized can be reduced, thereby increasing a generation rate of the target model to some extent.

S404: Add the auxiliary training parameter to the fully connected layer to obtain a pre-trained model with the parameter added.

S405: Call the pre-trained model with the parameter added, to respectively generate a target word vector corresponding to each word vector in the plurality of word vectors according to the plurality of word vectors and the auxiliary training parameter.

In an embodiment, a manner in which the computer device generates a target word vector of any word vector according to the plurality of word vectors and the auxiliary training parameter may be as follows: performing, by the computer device, a matrix multiplication operation on the auxiliary training matrix and the any word vector first to obtain a third reference word vector of the any word vector, to further generate the target word vector corresponding to the any word vector according to the any word vector and the third reference word vector. Specifically, assuming that the any word vector is an i^{th} word vector, the computer device may first determine a feature representation (i.e., V_{token_i}) of the any word vector in manners shown in Formula 8 and Formula 9, to further perform layer normalization on the third reference word vector and the feature representation to obtain the target word vector corresponding to the any word vector. For example, the computer device may perform layer normalization in a manner shown in Formula 10.

$${V}_{token \_ i}^{′} = gel u ( {W}_{1} {V}_{token \_ i} + {b}_{1} ) \qquad Formula 8$$

In Formula 8, W₁ is a matrix parameter in the pre-trained model, V_{token_i} is the i^{th} word vector (used as the any word vector), and b₁ is an offset item, and is also a model parameter in the pre-trained model. V_{token_i}′ in Formula 8 represents a result obtained by performing a matrix multiplication operation on the i^{th} word vector and the offset item and then performing calculation through an activation function (e.g., sigmoid) or a more complex function (e.g., ReLU).

$${V}_{token \_ i}^{″} = {W}_{2} {V}_{token \_ i}^{′} + {b}_{2} \qquad Formula 9$$

In Formula 9, W₂ is a matrix parameter in the pre-trained model, V_{token_i} is the i^{th} word vector (used as the any word vector), and b₂ is an offset item, and is also a model parameter in the pre-trained model. V_{token_i}′ is a processing result obtained by correspondingly processing the i^{th} word vector by using the foregoing Formula 8.

$${V}_{new \_ token \_ i} = Layer\_norm ( {V}_{token \_ i}^{″} + {V}_{add \_ token \_ i} ) \qquad Formula 10$$

In Formula 10, V_{new_token_i} represents the target word vector corresponding to the i^{th} word vector, Layer_norm represents layer normalization, V_{token_i}″ represents a feature representation of the i^{th} word vector in the fully connected layer, and V_{add_token_i} represents the third reference word vector corresponding to the i^{th} word vector. When one auxiliary training parameter is provided, the computer device may perform a matrix multiplication operation on the auxiliary training matrix and the word vector in a manner shown in Formula 11 to obtain the third reference word vector corresponding to the i^{th} word vector.

$${V}_{add \_ token \_ i} = {W}_{a d d} {V}_{token \_ i} \qquad Formula 11$$

In Formula 11, V_{add_token_i} represents the third reference word vector of the i^{th} word vector, W_{add} represents the auxiliary training matrix, and V_{token_i} represents the i^{th} word vector. In addition, when two auxiliary training parameters are provided, the computer device may perform a matrix multiplication operation on the auxiliary training matrix and the word vector in a manner shown in Formula 12 to obtain the third reference word vector corresponding to the i^{th} word vector.

$${V}_{add \_ token \_ i} = {W}_{add \_ 2} {W}_{add \_ 1} {V}_{token \_ i} \qquad Formula 12$$

In Formula 12, V_{add_token_i} represents the third reference word vector of the i^{th} word vector, V_{token_i} represents the i^{th} word vector, W_{add_2} represents the second auxiliary training matrix (or referred to as the second auxiliary training parameter), and W_{add_1} represents the first auxiliary training matrix (or referred to as the first auxiliary training parameter).

S406: Perform the target service based on the plurality of generated target word vectors to obtain a model prediction result corresponding to the training text.

S407: Optimize the auxiliary training parameter in a direction of reducing a difference between the model prediction result and the reference prediction result to obtain a target model, the target model being configured to perform the target service.

In an embodiment, for a specific implementation of operation S406 and operation S407, refer to related embodiments about operation S204 and operation S205. Details are not described herein again.

In the embodiments of this application, a target model is obtained by adding an auxiliary training matrix to a fully connected layer in a pre-trained model and optimizing the added auxiliary training matrix. The added auxiliary training matrix is configured for mapping an input feature (e.g., a word vector) into a higher-dimensional space, and mapping an output feature back into an input space, to enable the model to learn more complex nonlinear representations, to further capture complex relationships in a data set, thereby eventually improving the accuracy of the model. In addition, in the embodiments of this application, only an added auxiliary training parameter is optimized, and it is not necessary to optimize original model parameters in the pre-trained model, so that a quantity of model parameters that need to be optimized in a model optimization process is small, and a calculation amount of parameters required for the computer device to optimize a pre-trained model with parameters added is also significantly reduced. In this way, a training duration is effectively reduced, thereby reflecting the characteristic of a high rate of obtaining a target model in the embodiments of this application. In summary, as can be seen, the target model suitable for performing the target service can be efficiently generated in the embodiments of this application.

In an embodiment, based on the foregoing related embodiments about FIG. 2, FIG. 3, and FIG. 4, embodiments of this application further provide a method for generating a corresponding target word vector for any word vector. In the method, a computer device may respectively generate corresponding one or more auxiliary training parameters for a self-attention layer and a fully connected layer, to further generate the target word vector corresponding to the any word vector based on the auxiliary training parameter of the self-attention layer, the auxiliary training parameter of the fully connected layer, and a plurality of word vectors corresponding to a training text. For a manner in which the computer device generates the auxiliary training parameters for the self-attention layer and the fully connected layer, refer to the following description: During generation of the auxiliary training parameter for the self-attention layer, an auxiliary training word vector including vector elements of a target quantity may be first generated, and used as the auxiliary training parameter of the self-attention layer. The vector elements of the target quantity are randomly generated, the target quantity is a dimension of any word vector corresponding to the training text, and dimensions of the word vectors corresponding to the training text are the same. During generation of the auxiliary training parameter for the fully connected layer, reference vectors of the target quantity may be randomly generated, and an auxiliary training matrix is constructed according to the reference vectors of the target quantity, to use the auxiliary training matrix as the auxiliary training parameter of the fully connected layer. Matrix elements of the auxiliary training matrix are formed by the vector elements of the reference vectors of the target quantity, each reference vector includes N vector elements, and N is a positive integer less than or equal to the target quantity.

In an embodiment, after the auxiliary training parameters are generated and the auxiliary training parameters are added to a corresponding target network layer, the computer device may determine a vector similarity between the any word vector and each auxiliary training word vector, and determine a vector similarity between the any word vector and each word vector, to further generate a first backup word vector corresponding to the any word vector according to the vector similarity corresponding to each auxiliary training word vector, the vector similarity corresponding to each word vector, one or more auxiliary training word vectors corresponding to the training text, and the plurality of word vectors. Further, the computer device may perform a matrix multiplication operation on the auxiliary training matrix and the first backup word vector to obtain a second backup word vector corresponding to the any word vector, to enable the computer device to eventually generate the target word vector corresponding to the any word vector according to the second backup word vector and the any word vector. For an implementation of generating the first backup word vector by the computer device, refer to the foregoing related embodiment about generating a target word vector in operation S304. Details are not described herein again in this application. For a manner of obtaining the second backup word vector by the computer device, refer to the foregoing related embodiment about a target word vector in operation S304. Details are also not described herein again in the embodiments of this application. However, in this case, V_{token_i} in each of the foregoing Formula 8 to Formula 12 is the first backup word vector configured to the i^{th} word vector, and the meanings indicated by the other parameters remain unchanged.

As can be seen, in the embodiments of this application, a model prediction result corresponding to the training text is performed by a pre-trained model with a parameter added according to the target word vector corresponding to each word vector in the plurality of word vectors corresponding to the training text, and the auxiliary training parameter of the self-attention layer, the auxiliary training parameter of the fully connected layer, and the corresponding one or more word vectors are used during generation of the target word vector corresponding to each word vector, so that feature information represented by a target word vector corresponding to any word vector is obtained by combining feature information of the any word vector and feature information of the auxiliary training parameters. In other words, the feature information represented by the target word vector is more complex and comprehensive than the feature information represented by the corresponding word vector, so that feature information for reference by the pre-trained model with the parameter added in performing a target service is enriched, thereby improving the accuracy of an execution result of the target service. In addition, the pre-trained model with the parameter added performs the target service for the training text based on the feature information expressed by the target word vector to obtain the model prediction result corresponding to the training text, and a difference between the model prediction result and a reference prediction result is configured for optimizing the auxiliary training parameters added to the pre-trained model, to enable the auxiliary training parameter to be adjusted into a parameter suitable for executing the target service, so that a target model generated by using the embodiments of this application can have higher accuracy in performing the target service.

Based on the foregoing related embodiments of FIG. 2, FIG. 3, and FIG. 4, embodiments of this application further provide a model optimization apparatus. The apparatus may be a computer program run in the computer device described above. In specific embodiments, the model optimization apparatus may be configured to perform related operations in the model optimization methods shown in FIG. 2, FIG. 3, and FIG. 4. Referring to FIG. 5, the model optimization apparatus includes at least an obtaining unit 501, a determining unit 502, a generation unit 503, an execution unit 504, and an optimization unit 505.

The obtaining unit 501 is configured to obtain a pre-trained model and training data, the training data including a plurality of word vectors corresponding to a training text and a reference prediction result of the training text in a target service, and the plurality of word vectors at least including a word vector of each text word in the training text.

The determining unit 502 is configured to: determine an auxiliary training parameter of a target network layer in the pre-trained model, and add the auxiliary training parameter to the target network layer to obtain a pre-trained model with the parameter added.

The generation unit 503 is configured to call the pre-trained model with the parameter added, to respectively generate a target word vector corresponding to each word vector in the plurality of word vectors according to the plurality of word vectors and the auxiliary training parameter.

The execution unit 504 is configured to perform the target service based on the plurality of generated target word vectors to obtain a model prediction result corresponding to the training text.

The optimization unit 505 is configured to optimize the auxiliary training parameter in a direction of reducing a difference between the model prediction result and the reference prediction result to obtain a target model, the target model being configured to perform the target service.

In an implementation, the target network layer includes a self-attention layer, and an auxiliary training parameter of the self-attention layer includes at least one auxiliary training word vector; and when generating, for the any word vector in the plurality of word vectors, the target word vector corresponding to the any word vector according to the plurality of word vectors and the auxiliary training parameter, the generation unit 503 may further perform:
determining a vector similarity between the any word vector and each auxiliary training word vector, and determining a vector similarity between the any word vector and each word vector in the plurality of word vectors; and
generating the target word vector corresponding to the any word vector according to the vector similarity corresponding to each auxiliary training word vector, the vector similarity corresponding to each word vector, one or more auxiliary training word vectors, and the plurality of word vectors.

In another implementation, when being configured to generate the target word vector corresponding to the any word vector according to the vector similarity corresponding to each auxiliary training word vector, the vector similarity corresponding to each word vector, one or more auxiliary training word vectors, and the plurality of word vectors, the generation unit 503 may be further configured to perform:
determining a vector weight of each auxiliary training word vector according to the vector similarity corresponding to each auxiliary training word vector, and determining a vector weight of each word vector according to the vector similarity corresponding to each word vector, where the vector weight is positively correlated with the corresponding vector similarity;
performing a weighting operation on one or more auxiliary training word vectors based on each auxiliary training word vector and the corresponding vector weight to obtain a first reference word vector corresponding to the any word vector, and performing a weighting operation on the plurality of word vectors based on each word vector and the corresponding vector weight to obtain a second reference word vector corresponding to the any word vector; and
generating the target word vector corresponding to the any word vector according to the first reference word vector, the second reference word vector, and the any word vector.

In another implementation, a dimension of each word vector in the plurality of word vectors is a target quantity, the target network layer includes the self-attention layer, and at least one auxiliary training parameter of the self-attention layer is provided; and when being configured to determine the auxiliary training parameter of the self-attention layer, the determining unit 502 is further configured to perform:
randomly generating vector elements of the target quantity, and constructing an auxiliary training word vector including the vector elements of the target quantity; and
using the auxiliary training word vector as the auxiliary training parameter of the self-attention layer.

In another implementation, the target network layer includes a fully connected layer, and an auxiliary training parameter of the fully connected layer includes an auxiliary training matrix; and when being configured to generate the target word vector corresponding to the any word vector in the plurality of word vectors according to the plurality of word vectors and the auxiliary training parameter, the generation unit 503 may be further configured to perform:
performing a matrix multiplication operation on the auxiliary training matrix and the any word vector to obtain a third reference word vector corresponding to the any word vector; and
generating the target word vector corresponding to the any word vector according to the any word vector and the third reference word vector.

In another implementation, the dimension of each word vector in the plurality of word vectors is the target quantity, and the target network layer includes the fully connected layer; and when being configured to determine the auxiliary training parameter of the fully connected layer, the determining unit 502 may be further configured to perform:
randomly generating reference vectors of the target quantity, where each reference vector includes N vector elements, and N is a positive integer less than or equal to the target quantity; and
constructing the auxiliary training matrix according to the reference vectors of the target quantity, and using the auxiliary training matrix as the auxiliary training parameter of the fully connected layer, where matrix elements of the auxiliary training matrix are formed by the vector elements of the reference vectors of the target quantity.

In another implementation, a dimension of each word vector in the plurality of word vectors is a target quantity, the target network layer includes a self-attention layer and a fully connected layer, an auxiliary training parameter of the self-attention layer is at least one auxiliary training word vector, and an auxiliary training parameter of the fully connected layer is an auxiliary training matrix; and when being configured to generate, for the any word vector in the plurality of word vectors, the target word vector corresponding to the any word vector according to the plurality of word vectors and the auxiliary training parameter, the generation unit 503 may be further configured to perform:
determining a vector similarity between the any word vector and each auxiliary training word vector, and determining a vector similarity between the any word vector and each word vector;
generating a first backup word vector corresponding to the any word vector according to the vector similarity corresponding to each auxiliary training word vector, the vector similarity corresponding to each word vector, one or more auxiliary training word vectors, and the plurality of word vectors;
performing a matrix multiplication operation on the auxiliary training matrix and the first backup word vector to obtain a second backup word vector corresponding to the any word vector; and
generating the target word vector corresponding to the any word vector according to the second backup word vector and the any word vector.

In another implementation, the dimension of each word vector in the plurality of word vectors is the target quantity, and the target network layer includes the self-attention layer and the fully connected layer; and when being configured to determine the auxiliary training parameter of the target network layer in the pre-trained model, the determining unit 502 may be further configured to perform:
generating, for the self-attention layer, the auxiliary training word vector including the vector elements of the target quantity, and using the auxiliary training word vector as the auxiliary training parameter of the self-attention layer, where the vector elements of the target quantity are randomly generated; and
randomly generating, for the fully connected layer, reference vectors of the target quantity, constructing the auxiliary training matrix according to the reference vectors of the target quantity, and using the auxiliary training matrix as the auxiliary training parameter of the fully connected layer, where matrix elements of the auxiliary training matrix are formed by the vector elements of the reference vectors of the target quantity, each reference vector includes N vector elements, and N is a positive integer less than or equal to the target quantity.

According to an embodiment of this application, the operations in the model optimization methods shown in FIG. 2, FIG. 3, and FIG. 4 may be performed by the units in the model optimization apparatus shown in FIG. 5. For example, operation S201 in FIG. 2 may be performed by the obtaining unit 501 in the model optimization apparatus, operation S202 may be performed by the determining unit 502 in the model optimization apparatus, operation S203 may be performed by the generation unit 503 in the model optimization apparatus, operation S204 may be performed by the execution unit 504 in the model optimization apparatus, and operation S205 may be performed by the optimization unit 505 in the model optimization apparatus. For another example, operation S301 in FIG. 3 may be performed by the obtaining unit 501 in the model optimization apparatus, operation S302 and operation S303 may be performed by the determining unit 502 in the model optimization apparatus, operation S304 may be performed by the generation unit 503 in the model optimization apparatus, operation S305 may be performed by the execution unit 504 in the model optimization apparatus, and operation S306 may be performed by the optimization unit 505 in the model optimization apparatus. For still another example, operation S401 in FIG. 4 may be performed by the obtaining unit 501 in the model optimization apparatus, operation S402 to operation S404 may be performed by the determining unit 502 in the model optimization apparatus, operation S405 may be performed by the generation unit 503 in the model optimization apparatus, operation S406 may be performed by the execution unit 504 in the model optimization apparatus, and operation S407 may be performed by the optimization unit 505 in the model optimization apparatus.

According to another embodiment of this application, the units in the model optimization apparatus shown in FIG. 5 are divided based on logical functions. The foregoing units may be separately or all combined into one or several other units to form a structure, or one (some) of the units may be further divided into a plurality of functionally smaller units to form a structure. This can implement the same operations without affecting the implementation of the technical effects of the embodiments of this application. In other embodiments of this application, the model optimization apparatus may include other units. During actual application, the functions may be implemented with assistance of the other units, and may be implemented with assistance of a plurality of units.

According to another embodiment of this application, a computer program (including program code) that can perform the operations in the methods shown in FIG. 2, FIG. 3, and FIG. 4 may be run on a general-purpose communication device, for example, the foregoing computer device, including a processing element and a storage element, for example, a central processing unit (CPU), a random access storage medium (RAM), a read-only storage medium (ROM), to construct the model optimization apparatus shown in FIG. 5, and implement the model optimization method in the embodiments of this application. The computer program may be recorded in, for example, a computer storage medium, loaded into the foregoing computer device through the computer storage medium, and run in the computer device.

In the embodiments of this application, a target model is obtained by adding an auxiliary training parameter to a pre-trained model through the determining unit 502 and optimizing the added auxiliary training parameter by using the optimization unit 505. As can be seen, in a process of obtaining the target model, the optimization unit 505 optimizes only the added auxiliary training parameter in the pre-trained model, and original model parameters in the pre-trained model are kept unchanged, so that a quantity of model parameters that need to be optimized in a model optimization process is small. Therefore, when the model optimization apparatus optimizes the pre-trained model with the parameter added, a required calculation amount is greatly reduced. This is highly conducive to shortening an optimization time and saving a storage space, and the shortening of the optimization time reflects that the pre-trained model with the parameter added can quickly converge, so that the embodiments of this application has high efficiency of obtaining the target model. In addition, as the quantity of model parameters that need to be optimized is small, the model depends less on noise and special deviations in training data, so that model overfitting can be effectively mitigated, and the generated target model can have better generalization performance. In addition, the auxiliary training parameter may be added to a self-attention layer and/or a fully connected layer, and the self-attention layer and the fully connected layer usually include many parameters and have a complex use manner. Therefore, when the pre-trained model with the parameter added performs a target service based on the training data, complex interaction can be performed between the added auxiliary training parameter and existing parameters in the pre-trained model, so that the pre-trained model with the parameter added can use the auxiliary training parameter to learn more new features, and can better generalize new data. In this way, the target model obtained by optimizing the pre-trained model with the parameter added can better adapt to the target service. Therefore, the target model generated in the embodiments of this application can have higher accuracy in performing the target service. In summary, the target model suitable for performing the target service can be obtained through efficient optimization in the embodiments of this application.

Based on the foregoing related descriptions of the method embodiments and the apparatus embodiment, embodiments of this application further provide a computer device. Refer to FIG. 6. The computer device includes at least a processor 601 and a computer storage medium 602, and the processor 601 and the computer storage medium 602 are connected by a bus or in another manner. The computer storage medium 602 described above is a memory device in the computer device, and is configured to store a program and data. The computer storage medium 602 may include a built-in storage medium in the computer device, or may certainly include an extended storage medium supported by the computer device. The computer storage medium 602 provides a storage space, and the storage space stores an operating system of the computer device. In addition, one or more computer programs suitable for being loaded and executed by the processor 601 are further stored in the storage space, and these computer programs may be one or more pieces of program code. The computer storage medium may be a high-speed RAM memory, or may be a non-volatile memory, for example, at least one magnetic disk memory. In some embodiments, the computer storage medium may be at least one storage medium located far away from the processor. The processor 601 (or referred to as a CPU) is a computing core and a control core of the computer device, and is suitable for implementing one or more computer programs, and is specifically suitable for loading and executing one or more computer programs to implement corresponding method procedures or corresponding functions.

In an embodiment, the processor 601 may load and execute the one or more computer programs stored in the computer storage medium 602, to implement corresponding method operations in the foregoing method embodiments shown in FIG. 2, FIG. 3, and FIG. 4. In a specific implementation, the one or more computer programs in the computer storage medium 602 may be loaded by the processor 601 to perform the following operations:
obtaining a pre-trained model and training data, the training data including a plurality of word vectors corresponding to a training text and a reference prediction result of the training text in a target service, and the plurality of word vectors at least including a word vector of each text word in the training text;
determining an auxiliary training parameter of a target network layer in the pre-trained model, and adding the auxiliary training parameter to the target network layer to obtain a pre-trained model with the parameter added;
calling the pre-trained model with the parameter added, to respectively generate a target word vector corresponding to each word vector in the plurality of word vectors according to the plurality of word vectors and the auxiliary training parameter;
performing the target service based on the plurality of generated target word vectors to obtain a model prediction result corresponding to the training text; and
optimizing the auxiliary training parameter in a direction of reducing a difference between the model prediction result and the reference prediction result to obtain a target model, the target model being configured to perform the target service.

In an implementation, when generating, for the any word vector in the plurality of word vectors, the target word vector corresponding to the any word vector according to the plurality of word vectors and the auxiliary training parameter, the processor 601 may be further configured to perform:
determining a vector similarity between the any word vector and each auxiliary training word vector, and determining a vector similarity between the any word vector and each word vector in the plurality of word vectors; and
generating the target word vector corresponding to the any word vector according to the vector similarity corresponding to each auxiliary training word vector, the vector similarity corresponding to each word vector, one or more auxiliary training word vectors, and the plurality of word vectors.

In another implementation, when being configured to generate the target word vector corresponding to the any word vector according to the vector similarity corresponding to each auxiliary training word vector, the vector similarity corresponding to each word vector, one or more auxiliary training word vectors, and the plurality of word vectors, the processor 601 may be further configured to perform:
determining a vector weight of each auxiliary training word vector according to the vector similarity corresponding to each auxiliary training word vector, and determining a vector weight of each word vector according to the vector similarity corresponding to each word vector, where the vector weight is positively correlated with the corresponding vector similarity;
performing a weighting operation on one or more auxiliary training word vectors based on each auxiliary training word vector and the corresponding vector weight to obtain a first reference word vector corresponding to the any word vector, and performing a weighting operation on the plurality of word vectors based on each word vector and the corresponding vector weight to obtain a second reference word vector corresponding to the any word vector; and
generating the target word vector corresponding to the any word vector according to the first reference word vector, the second reference word vector, and the any word vector.

In another implementation, a dimension of each word vector in the plurality of word vectors is a target quantity, the target network layer includes the self-attention layer, and one or more auxiliary training parameters of the self-attention layer are provided; and when being configured to determine the auxiliary training parameter of the self-attention layer, the processor 601 may be further configured to perform:
randomly generating vector elements of the target quantity, and constructing an auxiliary training word vector including the vector elements of the target quantity; and
using the auxiliary training word vector as the auxiliary training parameter of the self-attention layer.

In another implementation, the target network layer includes a fully connected layer, and an auxiliary training parameter of the fully connected layer includes an auxiliary training matrix; and when being configured to generate the target word vector corresponding to the any word vector in the plurality of word vectors according to the plurality of word vectors and the auxiliary training parameter, the processor 601 may be further configured to perform:
performing a matrix multiplication operation on the auxiliary training matrix and the any word vector to obtain a third reference word vector corresponding to the any word vector; and
generating the target word vector corresponding to the any word vector according to the any word vector and the third reference word vector.

In another implementation, the dimension of each word vector in the plurality of word vectors is the target quantity, and the target network layer includes the fully connected layer; and when being configured to determine the auxiliary training parameter of the fully connected layer, the processor 601 may be further configured to perform:
randomly generating reference vectors of the target quantity, where each reference vector includes N vector elements, and N is a positive integer less than or equal to the target quantity; and
constructing the auxiliary training matrix according to the reference vectors of the target quantity, and using the auxiliary training matrix as the auxiliary training parameter of the fully connected layer, where matrix elements of the auxiliary training matrix are formed by the vector elements of the reference vectors of the target quantity.

In another implementation, a dimension of each word vector in the plurality of word vectors is a target quantity, the target network layer includes a self-attention layer and a fully connected layer, an auxiliary training parameter of the self-attention layer is at least one auxiliary training word vector, and an auxiliary training parameter of the fully connected layer is an auxiliary training matrix; and when generating, for the any word vector in the plurality of word vectors, the target word vector corresponding to the any word vector according to the plurality of word vectors and the auxiliary training parameter, the processor 601 may be further configured to perform:
determining a vector similarity between the any word vector and each auxiliary training word vector, and determining a vector similarity between the any word vector and each word vector;
generating a first backup word vector corresponding to the any word vector according to the vector similarity corresponding to each auxiliary training word vector, the vector similarity corresponding to each word vector, one or more auxiliary training word vectors, and the plurality of word vectors;
performing a matrix multiplication operation on the auxiliary training matrix and the first backup word vector to obtain a second backup word vector corresponding to the any word vector; and
generating the target word vector corresponding to the any word vector according to the second backup word vector and the any word vector.

In another implementation, the dimension of each word vector in the plurality of word vectors is the target quantity, and the target network layer includes the self-attention layer and the fully connected layer; and when being configured to determine the auxiliary training parameter of the target network layer in the pre-trained model, the processor 601 may be further configured to perform:
generating, for the self-attention layer, the auxiliary training word vector including the vector elements of the target quantity, and using the auxiliary training word vector as the auxiliary training parameter of the self-attention layer, where the vector elements of the target quantity are randomly generated; and
randomly generating, for the fully connected layer, reference vectors of the target quantity, constructing the auxiliary training matrix according to the reference vectors of the target quantity, and using the auxiliary training matrix as the auxiliary training parameter of the fully connected layer, where matrix elements of the auxiliary training matrix are formed by the vector elements of the reference vectors of the target quantity, each reference vector includes N vector elements, and N is a positive integer less than or equal to the target quantity.

In the embodiments of this application, a target model is obtained by adding an auxiliary training parameter to a pre-trained model and optimizing the added auxiliary training parameter. As can be seen, in a process of obtaining the target model, only the added auxiliary training parameter in the pre-trained model is optimized, and original model parameters in the pre-trained model are kept unchanged, so that a quantity of model parameters that need to be optimized in a model optimization process is small. Therefore, when the computer device optimizes the pre-trained model with the parameter added, a required calculation amount is greatly reduced. This is highly conducive to shortening an optimization time and saving a storage space, and the shortening of the optimization time reflects that the pre-trained model with the parameter added can quickly converge, so that the embodiments of this application have a high rate of obtaining the target model. In addition, as the quantity of model parameters that need to be optimized is small, the model depends less on noise and special deviations in training data, so that model overfitting can be effectively mitigated, and the obtained target model can have better generalization performance. In addition, the auxiliary training parameter may be added to a self-attention layer and/or a fully connected layer, and the self-attention layer and the fully connected layer usually include many parameters and have a complex use manner. Therefore, when the pre-trained model with the parameter added performs a target service based on the training data, complex interaction can be performed between the added auxiliary training parameter and existing parameters in the pre-trained model, so that the pre-trained model with the parameter added can use the auxiliary training parameter to learn more new features, and can better generalize new data. In this way, the target model obtained by optimizing the pre-trained model with the parameter added can better adapt to the target service. Therefore, the obtained target model in the embodiments of this application can have higher accuracy in performing the target service. In summary, the target model suitable for performing the target service can be obtained through efficient optimization in the embodiments of this application.

Embodiments of this application further provide a computer storage medium. The computer storage medium stores one or more computer programs corresponding to the foregoing model optimization method. When a processor loads and executes the one or more computer programs, the description of the model optimization method in the embodiments may be implemented. Details are not described herein again in the embodiments of this application. Correspondingly, the descriptions of beneficial effects of the same method are not described herein again. In addition, the computer program may be deployed on one device or a plurality of devices that can communicate with each other for execution.

In addition, according to an aspect of embodiments of this application, a program product or computer program is provided. The program product includes a computer program. The computer program is stored in a computer storage medium. A processor in a computer device reads the computer program from the computer storage medium, and then executes the computer program, to cause the computer device to perform the implementation methods provided for various optional manners in various aspects in the related embodiments of the model optimization methods shown in FIG. 2, FIG. 3, and FIG. 4.

A person of ordinary skill in the art may understand that all or a part of the procedures in the methods of the embodiments may be implemented by a computer program instructing relevant hardware. The computer program may be stored in a computer storage medium. The computer program is executed to perform the procedures related to all the foregoing embodiments of the model optimization methods. The computer storage medium may include a magnetic disk, an optical disc, a read-only memory (ROM), a random access memory (RAM), or the like.

In addition, the foregoing disclosure is some embodiments of this application, and certainly is not intended to limit the protection scope of this application. A person of ordinary skill in the art may understand that all or some of the processes in the foregoing embodiments, and make equivalent variations in accordance with the claims of this application shall fall within the scope of this application.

What is claimed is:

1. A model optimization method comprising:
obtaining a pre-trained model and training data, the training data including a plurality of word vectors corresponding to a training text and a reference prediction result of the training text in a target service, and the plurality of word vectors at least including a word vector of each text word in the training text;
determining an auxiliary training parameter of a target network layer in the pre-trained model, and adding the auxiliary training parameter to the target network layer to obtain a modified pre-trained model;
calling the modified pre-trained model to generate, according to the plurality of word vectors and the auxiliary training parameter, a plurality of target word vectors corresponding to the plurality of word vectors, respectively;
performing the target service based on the plurality of target word vectors to obtain a model prediction result corresponding to the training text; and
optimizing the auxiliary training parameter in a direction of reducing a difference between the model prediction result and the reference prediction result to obtain a target model.

2. The method according to claim 1, wherein:
the target network layer includes a self-attention layer, and an auxiliary training parameter of the self-attention layer includes at least one auxiliary training word vector; and
generating the plurality of target word vectors includes, for one word vector of the plurality of word vectors:
determining a vector similarity between the one word vector and each auxiliary training word vector;
determining a vector similarity between the one word vector and each word vector in the plurality of word vectors; and
generating the target word vector corresponding to the one word vector according to the vector similarity corresponding to each auxiliary training word vector, the vector similarity corresponding to each word vector, the at least one auxiliary training word vector, and the plurality of word vectors.

3. The method according to claim 2, wherein generating the target word vector corresponding to the one word vector includes:
determining a vector weight of each auxiliary training word vector according to the vector similarity corresponding to the auxiliary training word vector, and determining a vector weight of each word vector according to the vector similarity corresponding to the word vector, the vector weight is positively correlated with the corresponding vector similarity;
performing a weighting operation on the at least one auxiliary training word vector based on each auxiliary training word vector and the corresponding vector weight to obtain a first reference word vector corresponding to the one word vector, and performing a weighting operation on the plurality of word vectors based on each word vector and the corresponding vector weight to obtain a second reference word vector corresponding to the one word vector; and
generating the target word vector corresponding to the one word vector according to the first reference word vector, the second reference word vector, and the one word vector.

4. The method according to claim 1,
wherein:
a dimension of each word vector in the plurality of word vectors is a target quantity; and
the target network layer includes a self-attention layer having at least one auxiliary training parameter; and
the method further comprising:
randomly generating vector elements of the target quantity; and
constructing an auxiliary training word vector including the vector elements of the target quantity as one of the at least one auxiliary training parameter of the self-attention layer.

5. The method according to claim 1, wherein:
the target network layer includes a fully connected layer, and an auxiliary training parameter of the fully connected layer includes an auxiliary training matrix; and
generating the plurality of target word vectors includes, for one word vector of the plurality of word vectors:
performing a matrix multiplication operation on the auxiliary training matrix and the one word vector to obtain a reference word vector corresponding to the one word vector; and
generating the target word vector corresponding to the one word vector according to the one word vector and the reference word vector.

6. The method according to claim 1,
wherein:
a dimension of each word vector in the plurality of word vectors is a target quantity; and
the target network layer includes a fully connected layer;
the method further comprising:
randomly generating reference vectors of the target quantity, each reference vector including N vector elements, and N being a positive integer less than or equal to the target quantity; and
constructing an auxiliary training matrix of the fully connected layer according to the reference vectors of the target quantity as an auxiliary training parameter of the fully connected layer, matrix elements of the auxiliary training matrix being the vector elements of the reference vectors.

7. The method according to claim 1, wherein:
a dimension of each word vector in the plurality of word vectors is a target quantity;
the target network layer includes a self-attention layer and a fully connected layer, an auxiliary training parameter of the self-attention layer includes at least one auxiliary training word vector, and an auxiliary training parameter of the fully connected layer includes an auxiliary training matrix; and
generating the plurality of target word vectors includes, for one word vector of the plurality of word vectors:
determining a vector similarity between the one word vector and each auxiliary training word vector, and determining a vector similarity between the one word vector and each word vector of the plurality of word vectors;
generating a first backup word vector corresponding to the one word vector according to the vector similarity corresponding to each auxiliary training word vector, the vector similarity corresponding to each word vector, the at least one auxiliary training word vector, and the plurality of word vectors;
performing a matrix multiplication operation on the auxiliary training matrix and the first backup word vector to obtain a second backup word vector corresponding to the one word vector; and
generating the target word vector corresponding to the one word vector according to the second backup word vector and the one word vector.

8. The method according to claim 1,
wherein:
the dimension of each word vector in the plurality of word vectors is a target quantity; and
the target network layer includes a self-attention layer and a fully connected layer;
the method further comprising:
for the self-attention layer:
randomly generating vector elements of a target quantity; and
generating an auxiliary training word vector including the vector elements of the target quantity as an auxiliary training parameter of the self-attention layer; and
for the fully connected layer:
randomly generating reference vectors of the target quantity;
constructing an auxiliary training matrix according to the reference vectors as an auxiliary training parameter of the fully connected layer, matrix elements of the auxiliary training matrix including vector elements of the reference vectors, each reference vector including N vector elements, and N being a positive integer less than or equal to the target quantity.

9. The method according to claim 1, wherein the pre-trained model includes a transformer model.

10. A computer device comprising:
a processor; and
a computer storage medium storing one or more computer programs that, when executed by the processor, cause the processor to:
obtain a pre-trained model and training data, the training data including a plurality of word vectors corresponding to a training text and a reference prediction result of the training text in a target service, and the plurality of word vectors at least including a word vector of each text word in the training text;
determine an auxiliary training parameter of a target network layer in the pre-trained model, and adding the auxiliary training parameter to the target network layer to obtain a modified pre-trained model;
call the modified pre-trained model to generate, according to the plurality of word vectors and the auxiliary training parameter, a plurality of target word vectors corresponding to the plurality of word vectors, respectively;
perform the target service based on the plurality of target word vectors to obtain a model prediction result corresponding to the training text; and
optimize the auxiliary training parameter in a direction of reducing a difference between the model prediction result and the reference prediction result to obtain a target model.

11. The computer device according to claim 10, wherein:
the target network layer includes a self-attention layer, and an auxiliary training parameter of the self-attention layer includes at least one auxiliary training word vector; and
the one or more computer programs, when executed by the processor, further cause the processor to, when generating the plurality of target word vectors, for one word vector of the plurality of word vectors:
determine a vector similarity between the one word vector and each auxiliary training word vector;
determine a vector similarity between the one word vector and each word vector in the plurality of word vectors; and
generate the target word vector corresponding to the one word vector according to the vector similarity corresponding to each auxiliary training word vector, the vector similarity corresponding to each word vector, the at least one auxiliary training word vector, and the plurality of word vectors.

12. The computer device according to claim 11, wherein the one or more computer programs, when executed by the processor, further cause the processor to, when generating the target word vector corresponding to the one word vector:
determine a vector weight of each auxiliary training word vector according to the vector similarity corresponding to the auxiliary training word vector, and determining a vector weight of each word vector according to the vector similarity corresponding to the word vector, the vector weight is positively correlated with the corresponding vector similarity;
perform a weighting operation on the at least one auxiliary training word vector based on each auxiliary training word vector and the corresponding vector weight to obtain a first reference word vector corresponding to the one word vector, and performing a weighting operation on the plurality of word vectors based on each word vector and the corresponding vector weight to obtain a second reference word vector corresponding to the one word vector; and
generate the target word vector corresponding to the one word vector according to the first reference word vector, the second reference word vector, and the one word vector.

13. The computer device according to claim 10, wherein:
a dimension of each word vector in the plurality of word vectors is a target quantity;
the target network layer includes a self-attention layer having at least one auxiliary training parameter; and
the one or more computer programs, when executed by the processor, further cause the processor to:
randomly generate vector elements of the target quantity; and
construct an auxiliary training word vector including the vector elements of the target quantity as one of the at least one auxiliary training parameter of the self-attention layer.

14. The computer device according to claim 10, wherein:
the target network layer includes a fully connected layer, and an auxiliary training parameter of the fully connected layer includes an auxiliary training matrix; and
the one or more computer programs, when executed by the processor, further cause the processor to, when generating the plurality of target word vectors, for one word vector of the plurality of word vectors:
perform a matrix multiplication operation on the auxiliary training matrix and the one word vector to obtain a reference word vector corresponding to the one word vector; and
generate the target word vector corresponding to the one word vector according to the one word vector and the reference word vector.

15. The computer device according to claim 10, wherein:
a dimension of each word vector in the plurality of word vectors is a target quantity;
the target network layer includes a fully connected layer; and
the one or more computer programs, when executed by the processor, further cause the processor to:
randomly generate reference vectors of the target quantity, each reference vector including N vector elements, and N being a positive integer less than or equal to the target quantity; and
construct an auxiliary training matrix of the fully connected layer according to the reference vectors of the target quantity as an auxiliary training parameter of the fully connected layer, matrix elements of the auxiliary training matrix being the vector elements of the reference vectors.

16. The computer device according to claim 10, wherein:
a dimension of each word vector in the plurality of word vectors is a target quantity;
the target network layer includes a self-attention layer and a fully connected layer, an auxiliary training parameter of the self-attention layer includes at least one auxiliary training word vector, and an auxiliary training parameter of the fully connected layer includes an auxiliary training matrix; and
the one or more computer programs, when executed by the processor, further cause the processor to, when generating the plurality of target word vectors, for one word vector of the plurality of word vectors:
determine a vector similarity between the one word vector and each auxiliary training word vector, and determining a vector similarity between the one word vector and each word vector of the plurality of word vectors;
generate a first backup word vector corresponding to the one word vector according to the vector similarity corresponding to each auxiliary training word vector, the vector similarity corresponding to each word vector, the at least one auxiliary training word vector, and the plurality of word vectors;
perform a matrix multiplication operation on the auxiliary training matrix and the first backup word vector to obtain a second backup word vector corresponding to the one word vector; and
generate the target word vector corresponding to the one word vector according to the second backup word vector and the one word vector.

17. The computer device according to claim 10, wherein:
the dimension of each word vector in the plurality of word vectors is a target quantity; and
the target network layer includes a self-attention layer and a fully connected layer;
the one or more computer programs, when executed by the processor, further cause the processor to:
for the self-attention layer:
randomly generate vector elements of a target quantity; and
generate an auxiliary training word vector including the vector elements of the target quantity as an auxiliary training parameter of the self-attention layer; and
for the fully connected layer:
randomly generate reference vectors of the target quantity;
construct an auxiliary training matrix according to the reference vectors as an auxiliary training parameter of the fully connected layer, matrix elements of the auxiliary training matrix including vector elements of the reference vectors, each reference vector including N vector elements, and N being a positive integer less than or equal to the target quantity.

18. The computer device according to claim 10, wherein the pre-trained model includes a transformer model.

19. A non-transitory computer storage medium storing one or more computer programs that, when executed by a processor, cause the processor to:
obtain a pre-trained model and training data, the training data including a plurality of word vectors corresponding to a training text and a reference prediction result of the training text in a target service, and the plurality of word vectors at least including a word vector of each text word in the training text;
determine an auxiliary training parameter of a target network layer in the pre-trained model, and adding the auxiliary training parameter to the target network layer to obtain a modified pre-trained model;
call the modified pre-trained model to generate, according to the plurality of word vectors and the auxiliary training parameter, a plurality of target word vectors corresponding to the plurality of word vectors, respectively;
perform the target service based on the plurality of target word vectors to obtain a model prediction result corresponding to the training text; and
optimize the auxiliary training parameter in a direction of reducing a difference between the model prediction result and the reference prediction result to obtain a target model.

20. The non-transitory computer storage medium according to claim 19, wherein:
the target network layer includes a self-attention layer, and an auxiliary training parameter of the self-attention layer includes at least one auxiliary training word vector; and
the one or more computer programs, when executed by the processor, further cause the processor to, when generating the plurality of target word vectors, for one word vector of the plurality of word vectors:
determine a vector similarity between the one word vector and each auxiliary training word vector;
determine a vector similarity between the one word vector and each word vector in the plurality of word vectors; and
generate the target word vector corresponding to the one word vector according to the vector similarity corresponding to each auxiliary training word vector, the vector similarity corresponding to each word vector, the at least one auxiliary training word vector, and the plurality of word vectors.
